(19) United States
(12) Patent Application Publication
(10) Pub. No.: US 2010/0006362 A1
(43) Pub. Date: Jan. 14, 2010

(54) Vehicle Suspension Kinetic Energy Recovery System

(76) Inventor: Larry D. Armstrong, Eufaula, OK (US)

Correspondence Address: James T. Robinson;Exclusivity-Law, Inc., 222 East Main Street, Norman, OK, 73069-1303, US

(21) Appl. No.: 12/172,569

(22) Filed: Jul. 14, 2008

(51) Int. Cl. B60K 25/10; F03G 7/08

(52) U.S. Cl. 180/165; 290/1 R

(57) ABSTRACT

A vehicle suspension kinetic energy recovery system generates useful energy from the up-and-down motion of a vehicle suspension caused by roadway irregularities as the vehicle travels down the roadway. In one embodiment, a piston-type pump mounted between the frame and the suspension charges a high-pressure accumulator for driving hydraulic motors, e.g., power windows, power seats, alternator, etc. In another embodiment, electricity is generated directly by a conductor moving with respect to magnetic field as a result of the up-and-down motion of the vehicle suspension. In yet another embodiment, an air compressor mounted between the frame and suspension compresses air for storage in a pressure tank and, thereafter, to power pneumatic devices.

### BACKGROUND OF THE INVENTION

1. Field of the Invention

This invention relates to a vehicle suspension kinetic energy recovery system and, more particularly, but not by way of limitation, to a method and apparatus for converting the kinetic energy of vehicle suspension movement to useful energy.

2. Discussion

World-wide demand for oil increasingly strains the available supply. The need for more oil means higher prices and more pollution.

With gas prices on the rise, people and businesses are looking for environmentally sound solutions. New technologies have emerged to combat rising gas prices and decrease pollution. Fuel cell vehicles run on hydrogen and emit only water vapor. Biofuel vehicles run on fuel made from plants. Electric vehicles can run on rechargeable batteries, and hybrid vehicles use a combination of a gasoline engine and another type of power plant.

A hybrid pairing a gasoline engine with an electric motor powered by lithium ion batteries results in increased fuel economy and reduced pollution. A process called regenerative braking charges the batteries when the car brakes, thereby converting friction energy, which is normally lost in conventional vehicles, to electrical energy stored within the lithium ion batteries. The lithium ion batteries then power the electric motor. The electric motor in most cars generally is sufficiently powerful only to move the car at slow speeds. In most gas/electric hybrids, the gas engine takes over once the car reaches a speed of 20-30 miles per hour. Thereafter, the car operates like a conventional gasoline powered vehicle. Still, use of gas/electric hybrids cuts down on fuel consumption and emissions.

Although gas/electric hybrids use less fuel and generate less pollution than conventional cars, they have limitations. Extra batteries and the electric motor add substantial weight to the car, thereby decreasing efficiency. The batteries contain toxic materials which present disposal problems. As stated earlier, once a gas/electric hybrid reaches a speed of 20-30 miles per hour, it operates as a conventional gasoline-powered vehicle (but with extra weight due to the batteries and the electric motor).

Hydraulic hybrids pair a gasoline engine with a hydraulic power plant. A pump moves hydraulic fluid from a low-pressure reservoir to a high-pressure accumulator. The accumulator contains not only the fluid supplied by the pump but also pressurized nitrogen gas. As with gas/electric hybrids, regenerative braking gathers the energy which is stored in the high-pressure accumulator. Kinetic energy from the brakes powers the pump. As the vehicle slows, the pump starts up and moves fluid from the reservoir to the accumulator. The increased pressure in the accumulator acts like a fully charged battery in a gas/electric hybrid. Hydraulic hybrids offer an advantage over gas/electric hybrids, however, in that the accumulator sends its energy (in the form of nitrogen gas) directly to the vehicle's drive shaft. The vehicle accelerates and the pump moves the fluid back to the reservoir, ready to charge the accumulator again on the next application of the vehicle brakes.

All hydraulic hybrids use reservoirs, accumulators, and pumps, but those components can be coupled with a vehicle in two ways. A parallel hydraulic hybrid simply connects the hybrid components to a conventional transmission and drive shaft. This approach allows the hydraulic system to assist the gasoline engine in acceleration—when the gasoline engine works its hardest—but it does not allow the gasoline engine to shut off when the vehicle isn't in motion. Thus the vehicle is always burning gasoline, unlike gas/electric hybrids, whose engines shut off at slow speeds or when the vehicle is stopped. Still, the parallel hydraulic system provides significant benefits, including a 40 percent increase in fuel economy, according to the United States Environmental Protection Agency (EPA). Parallel hybrid systems are also adaptable for addition to conventional gasoline-powered vehicles. Currently, however, parallel hydraulic vehicles are built with the system in place and are used primarily in heavy-duty delivery vehicles.

Series hydraulic systems, while using the same regenerative braking process as parallel hydraulic systems, do not use a conventional transmission or drive shaft and transmit power almost directly to the wheels. Fewer components makes series hydraulic systems more efficient. Since the hydraulic system itself is turning the wheels, the vehicle's gasoline engine can be shut off, resulting in even more fuel savings. According to NextEnergy, a Michigan nonprofit organization founded in 2002 to accelerate research, development and manufacturing of alternative energy techniques, series hydraulic hybrids are estimated to improve fuel economy by 60 to 70 percent with a comparable reduction in emissions. In 2005, the EPA announced that it had partnered with UPS and Eaton Corporation-Fluid Power to create a number of series hydraulic-powered trucks for UPS. The truck looks like a regular UPS delivery van, but it has a series hydraulic hybrid propulsion system.

The EPA chose to put its efforts into a delivery van, rather than a passenger car, because of the source of the power. The hydraulic hybrid system (whether parallel or series) gets its power through regenerative braking. At highway speeds, a hydraulic hybrid isn't much different from a regular car. In traffic, however (especially in stop-and-go traffic), a series hydraulic hybrid can shut its engine off and use hydraulic power alone. Stopping and starting is the key to saving fuel with a hydraulic hybrid. Because UPS trucks encounter a lot of stop-and-go traffic, they are the perfect vehicle for hydraulic hybrid systems. UPS trucks go from one stop to the next, often in urban traffic, and seldom travel on the highway. They are also often left on as drivers make pickups and deliveries. In conventional UPS trucks, the idling vehicle creates pollution and adds to the company's fuel costs. The series hydraulic hybrid truck permits the gasoline engine to be shut off while the truck is on. Moreover, by cutting the fuel used and pollutants emitted by one large truck, there is a bigger impact overall than cutting the fuel and pollution of a smaller vehicle.

The increases in fuel economy associated with a series hydraulic hybrid generate huge savings, both financially and environmentally. Because the energy in a hydraulic hybrid doesn't pass through an electric motor, it recovers more energy normally lost during braking. According to NextEnergy, a gas/electric hybrid recovers 30 percent of braking energy, while a hydraulic hybrid can recover 70 percent. The EPA estimates that carbon dioxide emissions from hydraulic hybrid UPS trucks are 40 percent lower than conventional UPS trucks. The EPA also estimates that with less maintenance than a gas/electric hybrid and less fuel than a conventional truck, UPS could save up to $50,000 over the life span of each hydraulic hybrid truck. Another payoff lies in the efficiency of the hydraulic components themselves. Because the hydraulic components are lightweight and use simple mechanics, they are easy to build, maintain, and repair. In contrast, gas/electric hybrids use heavy batteries that may become obsolete and generate hazardous disposal challenges.

Yet current hydraulic hybrid vehicles have limitations. Their energy is derived solely from regenerative braking. At highway speeds, the absence of braking means no power can be produced by the hydraulic system. Even at low speeds, most modern cars have a number of electrical systems to power such things as radios, air conditioner fans, electrically-operated windows, electrically-adjusted seats, seat heaters, etc. Those systems are powered by a conventional car's battery, which is charged by the car's gasoline engine. If the engine shuts off and the electronics stay on, the battery is drained. In gas/electric hybrids, the extra batteries can keep the electrical components running while the engine is shut off during a stop. Hydraulic hybrids, however, lack the extra batteries needed to power electrical systems when the engine turns off. While the lack of extra batteries not a big deal for parallel hydraulic hybrids, whose engines do not shut off during vehicle stops, it is a major problem for series hydraulic hybrids. Series hydraulic hybrids offer the best fuel efficiency, but series hydraulic hybrids can't power a radio or air conditioner when the vehicle stops, making series hydraulic hybrids generally unsuitable for most American consumers.

The job of a car suspension is to maximize the friction between the tires and the road surface, to provide steering stability with good handling, and to ensure the comfort of the passengers. If a road were perfectly flat, with no irregularities, suspensions wouldn't be necessary. But roads are far from flat. Even freshly paved highways have subtle imperfections that can interact with the wheels of a car. These imperfections apply forces to the wheels. According to Newton's laws of motion, all forces have both magnitude and direction. A bump in the road causes the wheel to move up and down perpendicular to the road surface. The magnitude, of course, depends on whether the wheel is striking a giant bump or a tiny speck. Either way, the car wheel experiences a vertical acceleration as it passes over any roadway imperfection (sometimes also referred to herein as roadway irregularity).

Without an intervening structure, all of wheel's vertical energy is transferred to the frame, which moves in the same direction. In such a situation, the wheels can lose contact with the road completely. Then, under the downward force of gravity, the wheels can slam back into the road surface. The study of the forces at work on a moving car is called vehicle dynamics, and most automobile engineers consider the dynamics of a moving car from two perspectives—Ride and Handling. Ride is a car's ability to smooth out a bumpy road. Handling is a car's ability to safely accelerate, brake and corner. These two characteristics can be further described in three important principles—road isolation, road holding, and cornering.

Road isolation refers to the vehicle's ability to absorb or isolate road shock from the passenger compartment, thereby allowing the vehicle body to ride undisturbed while traveling over rough roads. The suspension absorbs energy from road bumps and dissipates the energy without causing undue oscillation in the vehicle.

Road holding refers to the degree to which a car maintains contact with the road surface in various types of directional changes and in a straight line. For example, the weight of a car will shift from the rear tires to the front tires during braking. Because the nose of the car dips toward the road, this type of motion is known as “dive.” The opposite effect—“squat”—occurs during acceleration, which shifts the weight of the car from the front tires to the back. The suspension keeps the tires in contact with the ground, because it is the friction between the tires and the road that affects a vehicle's ability to steer, brake and accelerate. The suspension also minimizes the transfer of vehicle weight from side to side and front to back, as this transfer of weight reduces the tire's grip on the road.

Cornering refers to the ability of a vehicle to travel a curved path. The suspension minimizes body roll, which occurs as centrifugal force pushes outward on a car's center of gravity while cornering, raising one side of the vehicle and lowering the opposite side. The suspension also transfers the weight of the car during cornering from the high side of the vehicle to the low side. Road isolation, road holding, and cornering involve almost constant vertical movement of the suspension with respect to the frame.

The suspension of a car is actually part of the chassis, which includes all of the important systems located beneath the car's body. These systems include the frame, the suspension system, the steering system, and the tires and wheels. The frame supports the car's engine and body, which are, in turn, supported by the suspension. The suspension supports weight, absorbs and dampens shock, and helps maintain tire contact with the roadway. The steering system enables the driver to guide and direct the vehicle. The tires and wheels make vehicle motion possible by way of or friction with the road.

The three fundamental components of any suspension are springs, dampers and anti-sway bars. Today's springing systems are based on one of four basic designs. Suspension coil springs are, essentially, a heavy-duty torsion bar coiled around an axis. Suspension coil springs compress and expand to absorb the motion of the wheels. Leaf springs consist of several layers of metal (called “leaves”) bound together to act as a single unit. Leaf springs were first used on horse-drawn carriages and were found on most American automobiles until 1985. They are still used today on most trucks and heavy-duty vehicles. Torsion bars use the twisting properties of a steel bar to provide coil-spring-like performance. One end of a bar is anchored to the vehicle frame. The other end is attached to a wishbone, which acts like a lever that moves perpendicular to the torsion bar. When the wheel hits a bump, vertical motion is transferred to the wishbone and then, through the levering action, to the torsion bar. The torsion bar then twists along its axis to provide the spring force. European car makers used this system extensively, as did Packard and Chrysler in the United States, through the 1950s and 1960s. Air springs, which consist of a cylindrical chamber of air positioned between the wheel and the car's body, use the compressive qualities of air to absorb wheel vibrations. The concept is actually more than a century old and could be found on horse-drawn buggies. Air springs from this era were made from air-filled, leather diaphragms, much like a bellows; they were replaced with molded-rubber air springs in the 1930s.

Based on where springs are located on a car—i.e., between the wheels and the frame—engineers often find it convenient to talk about the sprung mass and the unsprung mass. The sprung mass is the mass of the vehicle supported on the springs, while the unsprung mass is loosely defined as the mass between the road and the suspension springs. The stiffness of the springs affects how the sprung mass responds while the car is being driven. Loosely sprung cars, such as luxury cars, can swallow bumps and provide a super-smooth ride, but loosely sprung cars are prone to dive and squat during braking and acceleration and tends to experience body sway or roll during cornering. Tightly sprung cars, such as sports cars, are less forgiving on bumpy roads, but they minimize body motion well. Tightly sprung cars can be driven aggressively, even around corners. Whether loosely sprung or tightly sprung, the suspension of any vehicle is constantly moving relative to the frame.

While springs by themselves seem like simple devices, designing and implementing them on a car to balance passenger comfort with handling is a complex task. To make matters more complex, springs alone can't provide a perfectly smooth ride. Springs are great at absorbing energy, but not so good at dissipating it. Other structures, known as dampers, are required to do this.

Unless a dampening structure is present, a car spring will extend and release the energy it absorbs from a bump at an uncontrolled rate. The spring will continue to bounce at its natural frequency until all of the energy originally put into it is used up. A suspension built on springs alone would make for an extremely bouncy ride and, depending on the terrain, an uncontrollable car. The shock absorber, or snubber, controls unwanted spring motion through a process known as dampening. Shock absorbers slow down and reduce the magnitude of vibratory motions by turning the kinetic energy of suspension movement into heat energy that can be dissipated through hydraulic fluid.

A shock absorber is basically an oil pump placed between the frame of the car and the wheels. The upper mount of the shock connects to the frame (i.e., the sprung weight), while the lower mount connects to the axle, near the wheel (i.e., the unsprung weight). In a twin-tube design, one of the most common types of shock absorbers, the upper mount is connected to a piston rod, which in turn is connected to a piston, which in turn sits in a tube filled with hydraulic fluid. The inner tube is known as the pressure tube, and the outer tube is known as the reserve tube. The reserve tube stores excess hydraulic fluid. When the car wheel encounters a bump in the road and causes the spring to coil and uncoil, the energy of the spring is transferred to the shock absorber through the upper mount, down through the piston rod and into the piston. Orifices perforate the piston and allow fluid to leak through as the piston moves up and down in the pressure tube. Because the orifices are relatively tiny, only a small amount of fluid, under great pressure, passes through. This slows down the piston, which in turn slows down the spring.

Shock absorbers work in two cycles—the compression cycle and the extension cycle. The compression cycle occurs as the piston moves downward, compressing the hydraulic fluid in the chamber below the piston. The extension cycle occurs as the piston moves toward the top of the pressure tube, compressing the fluid in the chamber above the piston. A typical car or light truck will have more resistance during its extension cycle than its compression cycle. With that in mind, the compression cycle controls the motion of the vehicle's unsprung weight, while extension controls the heavier, sprung weight. All modern shock absorbers are velocity-sensitive—the faster the suspension moves, the more resistance the shock absorber provides. This enables shocks to adjust to road conditions and to control all of the unwanted motions that can occur in a moving vehicle, including bounce, sway, brake dive and acceleration squat.

Another common dampening structure is the strut—basically a shock absorber mounted inside a coil spring. Struts provide a dampening function like shock absorbers, and they also provide structural support for the vehicle suspension. That means struts deliver a bit more than shock absorbers, which don't support vehicle weight—they only control the speed at which weight is transferred in a car, not the weight itself. Because shocks and struts have so much to do with the handling of a car, they can be considered critical safety features. Worn shocks and struts can allow excessive vehicle-weight transfer from side to side and front to back. This reduces the tire's ability to grip the road, as well as handling and braking performance.

Anti-sway bars (also known as anti-roll bars) are used along with shock absorbers or struts to give a moving automobile additional stability. An anti-sway bar is a metal rod that spans the entire axle and effectively joins each side of the suspension together. When the suspension at one wheel moves up and down, the anti-sway bar transfers movement to the other wheel. This creates a more level ride and reduces vehicle sway. In particular, it combats the roll of a car on its suspension as it corners. Almost all cars today are fitted with anti-sway bars as standard equipment.

The stopping and starting requirement for regenerative braking on which current electric hybrids and hydraulic hybrids are based is unavailable at highway speeds. What is needed is a device which will capture the kinetic energy of suspension movement and generate power at highway speeds when regenerative braking is not available.

### SUMMARY OF THE INVENTION

A vehicle suspension kinetic energy recovery system generates useful energy from the up-and-down motion of a vehicle suspension caused by roadway irregularities as the vehicle travels down the roadway. In one embodiment, a piston-type pump is mounted between the frame and the suspension. When the vehicle frame moves toward the vehicle suspension in response to roadway irregularities, the piston pumps fluid from a low-pressure reservoir to a high-pressure accumulator. The energy stored in the high-pressure accumulator is available to power the vehicle. The energy thus made available can also be used to drive hydraulic motors, e.g., power windows, power seats, etc. In addition, the high pressure fluid can power an alternator which produces electricity for storage in a conventional automobile battery. In another embodiment, electricity is generated directly by a conductor moving with respect to magnetic field as a result of the up-and-down motion of the vehicle suspension. In yet another embodiment, an air compressor mounted between the frame and suspension compresses air for storage in a pressure tank and, thereafter, to power pneumatic devices.

An object of the present invention is to provide a method and system of recovering the kinetic energy associated with the movement of a vehicle frame relative to the vehicle suspension to power vehicle systems.

Yet another object of the present invention is to provide a vehicle suspension kinetic energy recovery system which absorbs a portion of the kinetic energy associated with the movement of a vehicle frame relative to the vehicle suspension and recover a portion of the kinetic energy associated with the movement of a vehicle frame relative to the vehicle suspension to power vehicle systems.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a block diagram of the functions of the applicant's vehicle suspension kinetic energy recovery system invention.

FIG. 2 shows a vehicle suspension kinetic energy recovery system according to applicant's vehicle suspension kinetic energy recovery system invention.

FIGS. 3-5 show the operation of applicant's vehicle suspension kinetic energy recovery system invention when the frame of a vehicle is compressed toward the vehicle suspension.

FIGS. 6-8 illustrate the operation of applicant's invention when the frame of a vehicle is extended away from the vehicle suspension.

FIG. 9 shows another vehicle suspension kinetic energy recovery system according to applicant's invention.

FIG. 10 shows another vehicle suspension kinetic energy recovery system according to applicant's invention.

FIG. 11 shows another vehicle suspension kinetic energy recovery system according to applicant's invention.

FIG. 12 shows another vehicle suspension kinetic energy recovery system according to applicant's invention.

FIG. 13 shows another vehicle suspension kinetic energy recovery system according to applicant's invention.

FIG. 14 shows another vehicle suspension kinetic energy recovery system according to applicant's invention.

FIG. 15 shows another vehicle suspension kinetic energy recovery system according to applicant's invention.

### DETAILED DESCRIPTION OF THE INVENTION

In the following description of the invention, like numerals and characters designate like elements throughout the figures of the drawings.

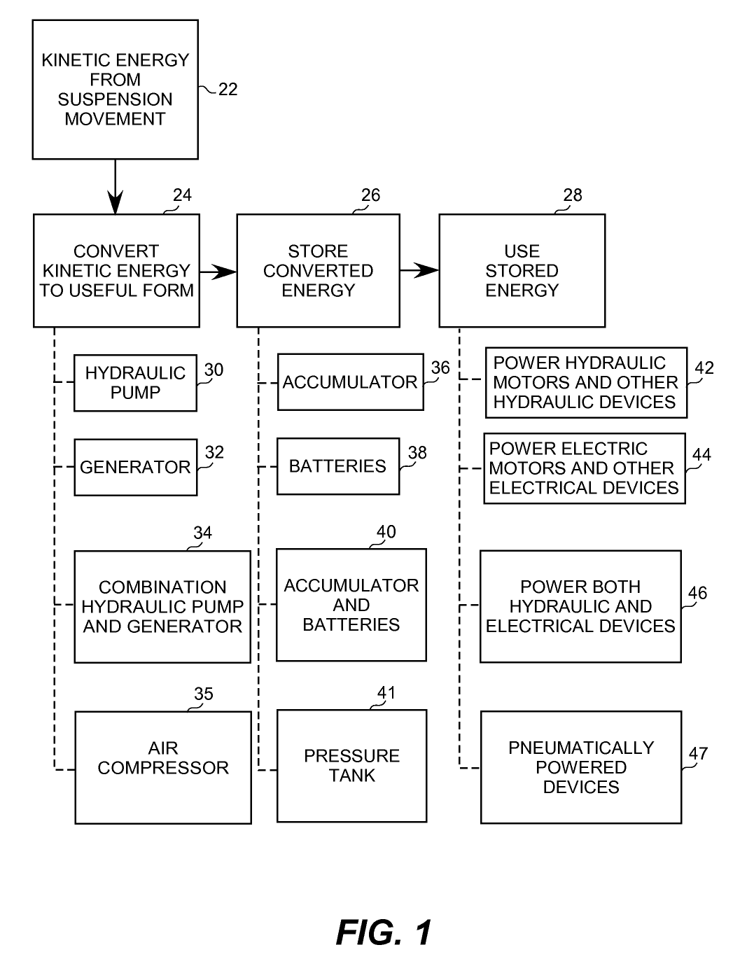

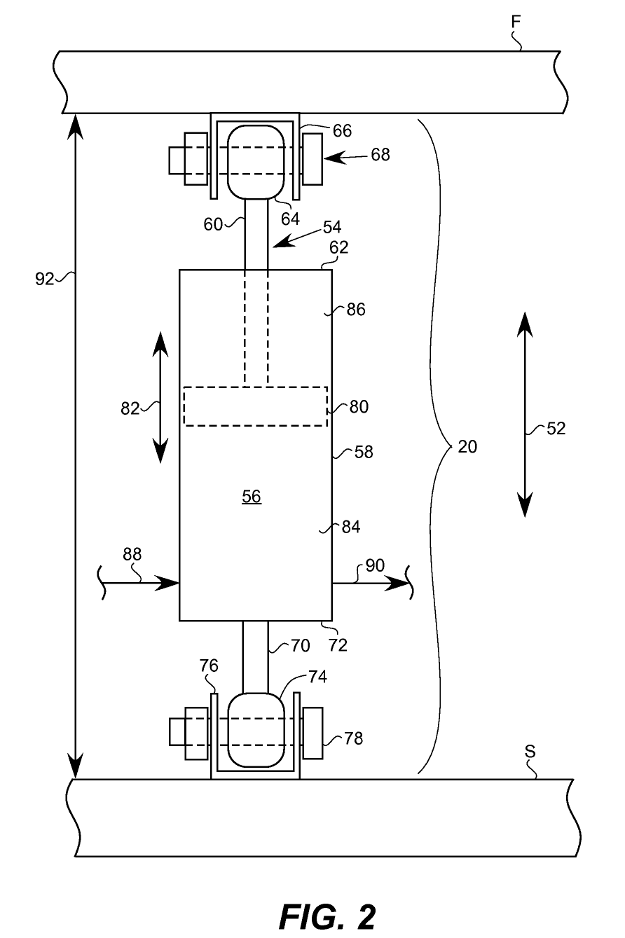

Referring generally to the drawings and more particularly to FIG. 1, a vehicle suspension kinetic energy recovery system 20 (See FIG. 2), also referred to sometimes herein as a converter, is adapted to receive energy in the form of kinetic energy from the movement of a vehicle suspension (Step 22) and convert that kinetic energy to energy which can be used in the operation of the vehicle (Step 24). In Step 26, the converted energy is stored. In step 28, the stored energy is used in the operation of the vehicle.

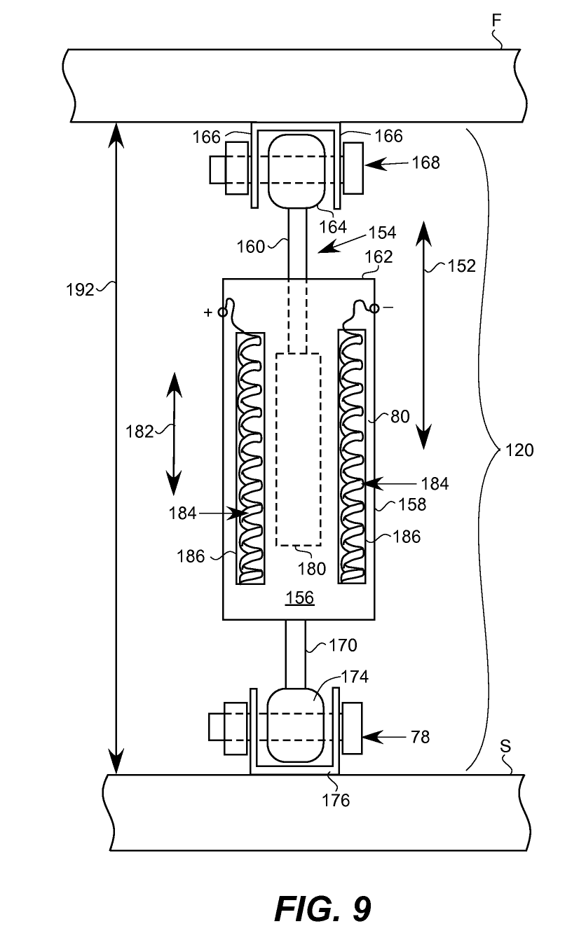

Still referring to FIG. 1, the conversion step 22 can be accomplished using a hydraulic pump mounted between the vehicle's frame and the vehicle's suspension as indicated in box 30 (See FIGS. 2-8). The conversion step 22 can also be accomplished using a generator mounted between the frame and suspension of the vehicle, as indicated in box 32 (See FIG. 9). The conversion step 22 can be accomplished using a hydraulic pump and a generator at the same time as indicated in box 34. Finally, the conversion step 22 can be accomplished using an air compressor as indicated in box 35.

Referring still to FIG. 1, the energy recovered during the conversion step 22 is stored in a hydraulic system accumulator if the conversion is achieved using a hydraulic pump, as indicated in box 36. The recovered energy is stored in one or more storage batteries if the conversion is achieved using a generator, as indicated in box 38. When both a hydraulic pump and a generator are used to recover the kinetic energy associated with the movement of the vehicle suspension, the energy will be stored in both a hydraulic system accumulator and one or more storage batteries, as indicated in box 40. Recovered energy can also be stored as compressed air in a pressure tank as indicated in box 41.

Referring still to FIG. 1, the uses of the stored energy captured by the vehicle suspension kinetic energy recovery system of the present invention are limitless. The stored energy from the high pressure accumulator can power hydraulic motors and other hydraulic devices, as indicated in box 42, and energy stored in the batteries can power electric motors and other electrical devices, as indicated in box 44. Box 46 illustrates the use of both forms of stored energy. Finally the stored energy from the pressure tank is used to operate pneumatically powered devices.

Referring now to FIG. 2, a hydraulic vehicle suspension kinetic energy recovery system 20 is deployed between the frame F and the suspension S of a vehicle. It will be understood by one skilled in the art that the vehicle suspension kinetic energy recovery system 20 can be deployed between the frame F and the suspension S at any convenient location. It will be further Understood by one skilled in the art that one or more vehicle suspension kinetic energy recovery systems 20 can be used on a single vehicle.

The hydraulic vehicle suspension kinetic energy recovery system 20 shown in FIG. 2 is similar to a conventional hydraulic ram. Whereas a conventional hydraulic ram uses high pressure hydraulic fluid from a hydraulic system accumulator to actuate the hydraulic ram, however, kinetic energy associated with the movement of the frame F relative to the suspension S along arrow 52 causes a piston 54 to transfer hydraulic fluid 56 within a cylinder 58 to a hydraulic system high-pressure accumulator (not shown). The piston 54 has a stem 60 which extends upwardly from one end 62 of the cylinder 58 and terminates in a swivel eye 64. The swivel eye 64 of the piston stem 60 is secured within a U-shaped bracket 66 attached to the frame F by a bolt-and-nut assembly 68. A member 70 attached to the other end 72 of the cylinder 58 terminates in a swivel eye 74. The swivel eye 74 of the member 70 is secured within a U-shaped bracket 76 attached to the suspension S by a bolt-and-nut assembly 78. Using terminology common to shock absorbers, the swivel eye 64 is an “upper mount” which attaches to the frame F, and the swivel eye 74 is a “lower mount” which attaches to the suspension S.

Still referring fo FIG. 2, the piston 54 has a head 80 which moves up and down along arrow 82 within the cylinder 58 as the frame F and the suspension S move alternately closer together and farther apart along the arrow 52 as a result of roadway irregularities. The position of the piston head 80 within the cylinder 58 defines a hydraulic fluid cavity 84 below the piston head 80 and an open cavity 86 above the piston head 80. An inlet conduit 88 provides one-way flow of hydraulic fluid 56 from a low-pressure reservoir (not shown) to the hydraulic fluid cavity 84, and an outlet conduit 90 provides one-way flow of the hydraulic fluid 56 from the hydraulic fluid cavity 84 to the high-pressure accumulator (not shown). The vehicle suspension kinetic energy recovery system 20 shown in FIG. 2 is illustrated when the vehicle is at rest, resulting in an at-rest distance 92 between the frame F and the suspension S.

It will be understood by one skilled in the art that the vehicle suspension kinetic energy recovery system 20 is, essentially, a positive-displacement piston pump. As the frame F and the suspension S move closer together along the arrow 52 (i.e., in a compression cycle), the vehicle suspension kinetic energy recovery system 20 charges the high-pressure hydraulic accumulator with hydraulic fluid 56 through the outlet conduit 90. As the frame F and the suspension move farther apart along the arrow 52 in an extension cycle, the vehicle suspension kinetic energy recovery system 20 pulls hydraulic fluid 56 from the low-pressure hydraulic fluid reservoir into the cavity 84 through the inlet conduit 88. It will be further understood that appropriate sealing rings are required between the piston head 80 and the interior surface of the cylinder 58. Thus the vehicle suspension kinetic energy recovery system 20 shown in FIG. 2 functions as a high pressure hydraulic pump wherein the compression cycle produces to a discharge stroke and the extension cycle produces a suction stroke. Because hydraulic cylinders and hydraulic pumps are well known in the art, the details of the sealing rings and other hydraulic cylinder components have been omitted for the sake of clarity. The appropriate use of check valves to achieve one-way flow is also well known in the art.

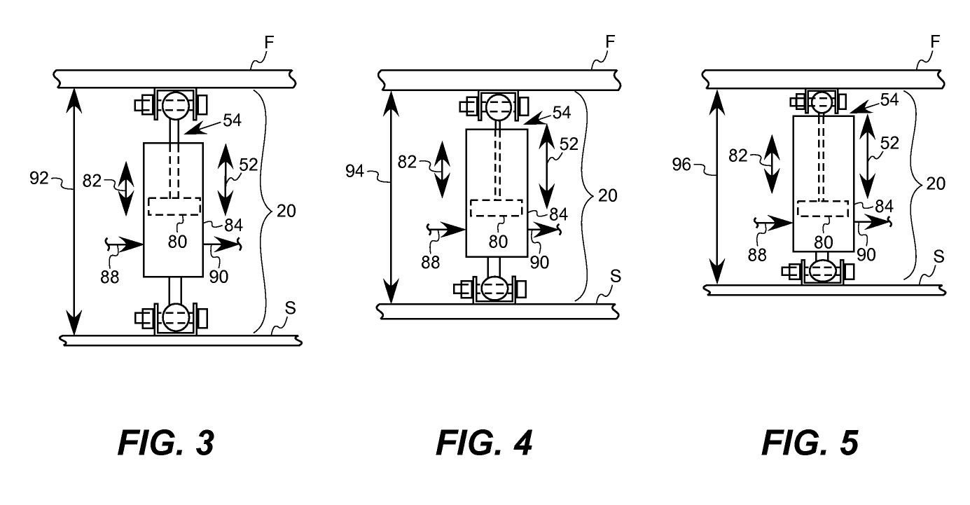

Referring now to FIGS. 3-5, operation of the vehicle suspension kinetic energy recovery system 20 during a compression cycle, i.e., when a roadway irregularity causes the frame F to move toward the suspension S, begins with the vehicle suspension kinetic energy recovery system 20 in the at-rest position (FIG. 5) and the frame F a distance 92 from the suspension S. In FIG. 4, the frame F is shown at relatively shorter distance 94 from the suspension S and the piston head 80 has moved along arrow 82 toward the bottom of the cylinder 58. During the compression cycle, the piston 54 forces hydraulic fluid 56 from the hydraulic fluid cavity 84 through the outlet conduit 90 to the high-pressure accumulator. In the event the roadway irregularity causes the frame F to move further toward the suspension S along arrow 52, as shown in FIG. 5, the piston 54 moves further toward the bottom of the cylinder 58 along arrow 82 and forces additional hydraulic fluid 56 from the cavity 84 through the outlet conduit 90 to the high-pressure accumulator.

It will be understood by one skilled in the art that the compression cycle described in FIGS. 3-5 converts kinetic energy from movement of the suspension S with respect to the frame F to useful energy stored in the high-pressure accumulator.

Still referring to FIGS. 3-5, when the frame F returns to the at-rest position shown in FIGS. 2 and 3, the piston 80 moves upward along arrow 82 within the cylinder 58 and pulls hydraulic fluid 56 into the cavity 84 from the low-pressure hydraulic fluid reservoir (not shown) through the inlet conduit 88. Thus the compression cycle produces a discharge stroke from the vehicle suspension kinetic energy recovery system 20.

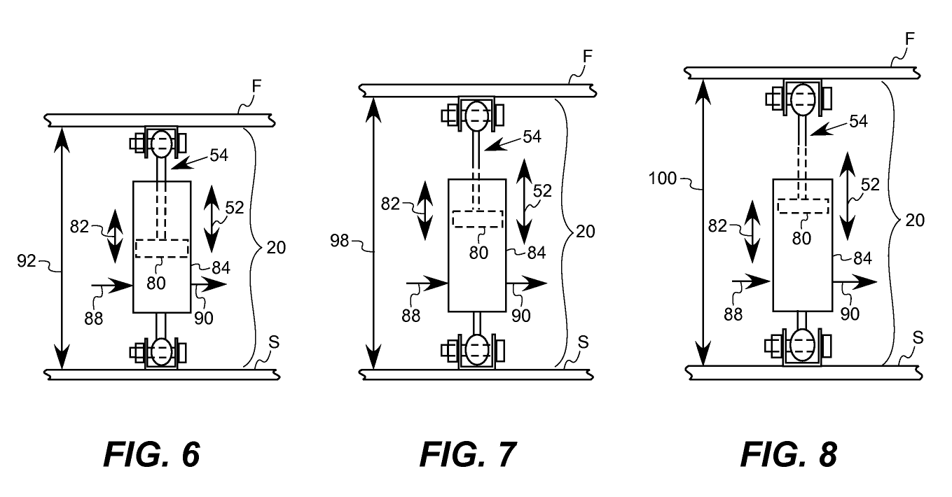

Referring now to FIGS. 6-8, operation of the vehicle suspension kinetic energy recovery system 20 during an extension cycle, i.e., when a roadway irregularity causes the frame F to move away from the suspension S along arrow 52, begins with the vehicle suspension kinetic energy recovery system 20 in the at-rest position (FIG. 6) and the frame F at the rest-position distance 92 from the suspension S. In FIG. 7, the frame F is shown at relatively greater distance 98 from the suspension S and the piston head 80 has moved along arrow 82 toward the top of the cylinder 58. During this suction stroke of the piston 54, hydraulic fluid 56 is pulled into the cavity 84 through the inlet conduit 88 from the low-pressure reservoir (not shown). In the event the roadway irregularity causes the frame F to move still farther away from the suspension S along arrow 52, as shown in FIG. 8, the piston 54 moves further toward the top of the cylinder 58 along arrow 82 and additional hydraulic fluid 56 is pulled into the cavity 84 through the inlet conduit 88 from the low-pressure reservoir.

Still referring to FIGS. 6-8, when the frame F returns to the at-rest position shown in FIGS. 6, 2 and 3, the piston 80 moves downward along arrow 82 within the cylinder 58 and forces hydraulic fluid 56 from the cavity 84 to the high-pressure accumulator (not shown) through the outlet conduit 90.

It will be understood by one skilled in the art that return of the vehicle suspension kinetic energy recovery system 20 to the at-rest position from the extension cycle described in FIGS. 6-8 results in the conversion of kinetic energy from movement of the suspension S with respect to the frame F to useful energy stored in the high-pressure accumulator. Thus, any movement of the frame F relative to the suspension S along arrow 52 results in the capture of kinetic energy for use in powering vehicle systems. Thus the extension cycle produces a suction stroke by the vehicle suspension kinetic energy recovery system 20.

Referring now to FIG. 9, another vehicle suspension kinetic energy recovery system 120 is deployed between the frame F and the suspension S of a vehicle. It will be understood by one skilled in the art that the vehicle suspension kinetic energy recovery system 120 can be deployed between the frame F and the suspension S at any convenient location. It will be further understood by one skilled in the art that one or more vehicle suspension kinetic energy recovery systems 120 can be used on a single vehicle.

Still referring to FIG. 9, the vehicle suspension kinetic energy recovery system 120 uses the movement of the frame F relative to the suspension S along arrow 152 to cause a magnet assembly 154 to move vertically to create a moving magnetic field. The magnet assembly 154 has a supporting stem 160 which extends upwardly from one end 162 of the cylinder 158 and terminates in a swivel eye 164, also sometimes referred to as an upper mount. The swivel eye 164 of the supporting stem 160 is secured within a U-shaped bracket 166 attached to the frame F by a bolt-and-nut assembly 168. A member 170 attached to the other end 172 of the cylinder 158 terminates in a swivel eye 174, also sometimes referred to as a lower mount. The swivel eye 174 of the member 170 is secured within a U-shaped bracket 176 attached to the suspension S by a bolt-and-nut assembly 178.

Still referring fo FIG. 9, the supporting stem 154 supports a permanent magnet 180 which moves up and down along arrow 182 within the cylinder 158 as the frame F and the suspension S move alternately closer together and farther apart along the arrow 152 as a result of roadway irregularities. The permanent magnet 180 moves within the cylinder 158 between coils 184 wrapped around coil supporting members 186. The vehicle suspension kinetic energy recovery system 120 shown in FIG. 9 is illustrated when the vehicle is at rest, resulting in an at-rest distance 192 between the frame F and the suspension S.

It will be understood by one skilled in the art that the vehicle suspension kinetic energy recovery system 120 is, essentially, a generator. As the frame F and the suspension S move closer together along the arrow 152 in a compression cycle, the vehicle suspension kinetic energy recovery system 120 charges storage batteries (not shown) with electricity for use in powering vehicle electrical systems. As the frame F and the suspension move farther apart along the arrow 152 in an extension cycle, the vehicle suspension kinetic energy recovery system 120 again charges storage batteries (not shown) with electricity for use in powering vehicle electrical systems. It will be further understood that appropriate auxiliary devices such as commutators may be required. Because generators are well known in the art, the details of the electrical system beyond the vehicle suspension kinetic energy recovery system 120 have been omitted for the sake of clarity.

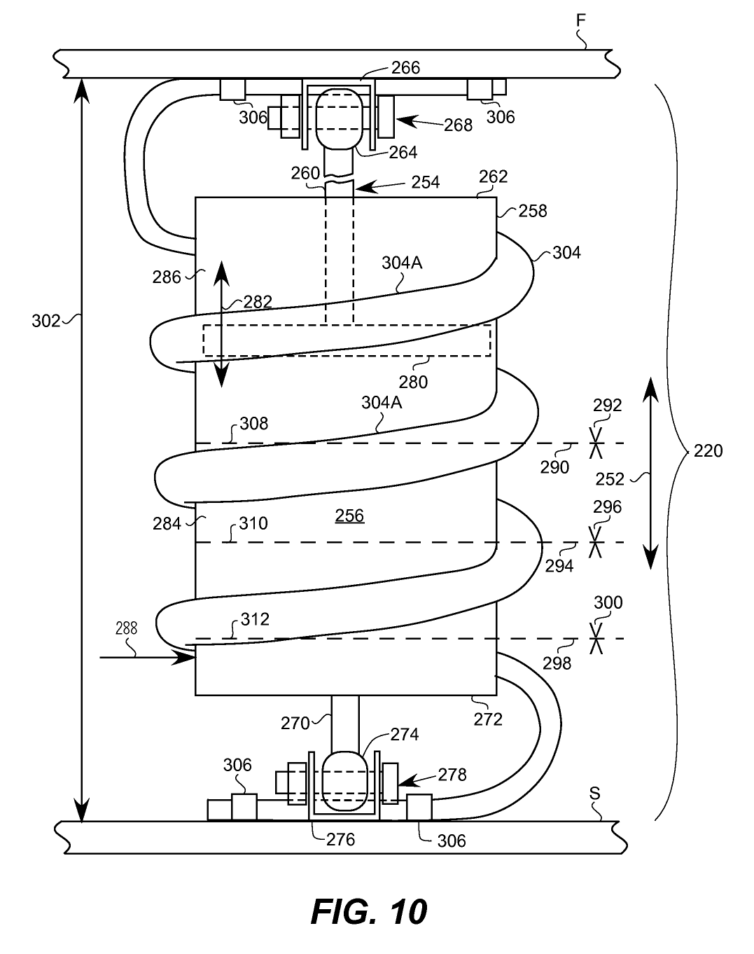

Referring now to FIG. 10, another hydraulic vehicle suspension kinetic energy recovery system 220 is deployed between the frame F and the suspension S of a vehicle. It will be understood by one skilled in the art that the vehicle suspension kinetic energy recovery system 220 can be deployed between the frame F and the suspension S at any convenient location. It will be further understood by one skilled in the art that one or more vehicle suspension kinetic energy recovery systems 220 can be installed on a single vehicle.

The hydraulic vehicle suspension kinetic energy recovery system 220 shown in FIG. 10 is similar to a conventional hydraulic ram. Whereas a conventional hydraulic ram uses high pressure hydraulic fluid from a hydraulic system accumulator to actuate the hydraulic ram, however, kinetic energy associated with the movement of the frame F relative to the suspension S along arrow 252 causes a piston 254 to transfer hydraulic fluid 256 within a cylinder 258 to a hydraulic system high-pressure accumulator (not shown). The piston 254 has a stem 260 which extends upwardly from one end 262 of the cylinder 258 and terminates in a swivel eye 264. The swivel eye 264 of the piston stem 260 is secured within a U-shaped bracket 266 attached to the frame F by a bolt-and-nut assembly 268. A member 270 attached to the other end 272 of the cylinder 258 terminates in a swivel eye 274. The swivel eye 274 of the member 270 is secured within a U-shaped bracket 276 attached to the suspension S by a bolt-and-nut assembly 278.

Still referring fo FIG. 10, the piston 254 has a head 280 which moves up and down along arrow 282 within the cylinder 258 as the frame F and the suspension S move alternately closer together (in a compression cycle) and farther apart (in an extension cycle) along the arrow 252 as a result of roadway irregularities. The position of the piston head 280 within the cylinder 258 defines a hydraulic fluid cavity 284 below the piston head 280 and an open cavity 286 above the piston head 280. An inlet conduit 288 provides one-way flow of hydraulic fluid 256 from a low-pressure reservoir (not shown) to the hydraulic fluid cavity 284. A series of one-way outlet conduits 290, 294, and 298 provide one-way flow of the hydraulic fluid 256 from the hydraulic fluid cavity 284 to the high-pressure accumulator (not shown) through progressively restrictive conduit orifices 292, 296, and 300, respectively. The vehicle suspension kinetic energy recovery system 220 shown in FIG. 10 is illustrated when the vehicle is at rest, resulting in an at-rest distance 302 between the frame F and the suspension S.

Still referring to FIG. 10, a suspension coil spring 304 is also deployed between the frame F and the suspension S. One end of the suspension coil spring 304 is secured to the frame F by clips 306, and the other end of the suspension coil spring 304 is secured to the suspension S by clips 306. The suspension coil spring 304 is of sufficient size to encompass the cylinder 258 disposed within the coils 304a, 304b, 304c of the suspension coil spring 304. It will be understood by on skilled in the art that the suspension coil spring 304 represented herein is well known in the art and the number of coils 304a, 304b, and 304c is for illustration only and not intended to be a precise representation of the number of coils in a state-of-the art suspension coil spring.

The vehicle suspension kinetic energy recovery system 220 shown in FIG. 10, like the vehicle suspension kinetic energy recovery systems 20 and 120 described above, charges a high-pressure hydraulic accumulator (now shown) with hydraulic fluid 256 as the frame F and the suspension S move closer together along the arrow 252. The inclusion of progressively restrictive conduit orifices 292, 296, 300 in the one-way outlet conduits 290, 294, 298, together with the deployment of the suspension coil spring 304, makes the vehicle suspension kinetic energy recovery system 220 a part of the vehicle suspension system as well. To illustrate the multifunction aspects of the vehicle suspension kinetic energy recovery system 200 of FIG. 10, we will describe the vehicle suspension kinetic energy recovery system 200 in operation.

Still referring to FIG. 10, as the frame F moves toward the suspension S along the arrow 252 due to roadway irregularities, the suspension coil spring 304 provides a progressive resistance against further compression. Simultaneously, the piston head 280 moves downwardly within the cylinder 258 towards the suspension S, thereby forcing the hydraulic fluid 256 from the cavity 284, through the one-way outlet conduits 290, 294, and 298 to the hydraulic accumulator (not shown). The orifice 292 in the one-way outlet conduit 290 is larger than the orifice 296 in the one-way outlet conduit 294, and the orifice 300 in the one-way outlet conduit 298 is smaller (i.e., more restrictive) than the orifice 296 in the one-way outlet conduit 294. Thus the hydraulic fluid 256, at the beginning of the compression of the frame F toward the suspension S, flows to the hydraulic accumulator preferentially through the one-way outlet conduit 290.

Still referring to FIG. 10, as the frame F moves further downwardly along the arrow 252 toward the suspension S, the piston 280 will eventually move downwardly past the level of the one-way outlet conduit 290, as indicated by a reference line 308. The suspension coil spring 304 provides increasing resistance. After the piston 280 moves downwardly past the level of the one-way outlet conduit 290, the hydraulic fluid 256 is forced from the progressively smaller cavity 284 to the hydraulic accumulator through one-way outlet conduits 294 and 298. Thus the reduced capacity of the one-way outlet conduits 294, 298 to move the hydraulic fluid 256 from the cavity 284 to the hydraulic accumulator—as compared to the combined capacity of one-way outlet conduits 290, 294, and 298—provides additional resistance to further compression of the frame F toward the suspension S. Thus the vehicle suspension kinetic energy recovery system 220 functions as a high pressure hydraulic pump. The compression cycle produces a discharge stroke, and the extension cycle produces a suction stroke.

Still referring to FIG. 10, as the frame F moves further downwardly along the arrow 252 toward the suspension S, the piston 280 will, at some point move downwardly past the level of the one-way outlet conduit 294, as indicated by a reference line 310. The suspension coil spring 304 will continue to provide increasing resistance. After the piston 280 moves downwardly past the level of the one-way outlet conduit 294, the hydraulic fluid 256 is forced from the progressively smaller cavity 284 to the hydraulic accumulator through the one-way outlet conduit 298. The reduced capacity of the one-way outlet conduit 298, to move the hydraulic fluid 26 from the cavity 284 to the hydraulic accumulator—as compared to the combined capacity of one-way outlet conduits 294 and 298—provides additional resistance to further compression of the frame F toward the suspension S.

Still referring to FIG. 10, as the frame F moves further downwardly along the arrow 252 toward the suspension S, the piston 280 will, at some point move downwardly past the level of the one-way outlet conduit 298, as indicated by a reference line 312. The suspension coil spring 304 will continue to provide increasing resistance. At the point the piston 280 moves downwardly past the level of the one-way outlet conduit 298, the hydraulic fluid 256 becomes trapped in a closed cavity having no outlet. Thus no further movement of the frame F toward the suspension S is permitted.

It will be understood by one skilled in the art that the vehicle suspension kinetic energy recovery system 220 shown in FIG. 10 replaces the existing shock absorbers and/or struts, thereby stabilizing the operation of the vehicle while converting kinetic energy associated with movement of the suspension to energy for powering the vehicle and vehicle systems. In vehicle dynamics terminology, the suspension coil spring 304 absorbs energy and the conversion of kinetic energy to high pressure hydraulic fluid energy dissipates energy.

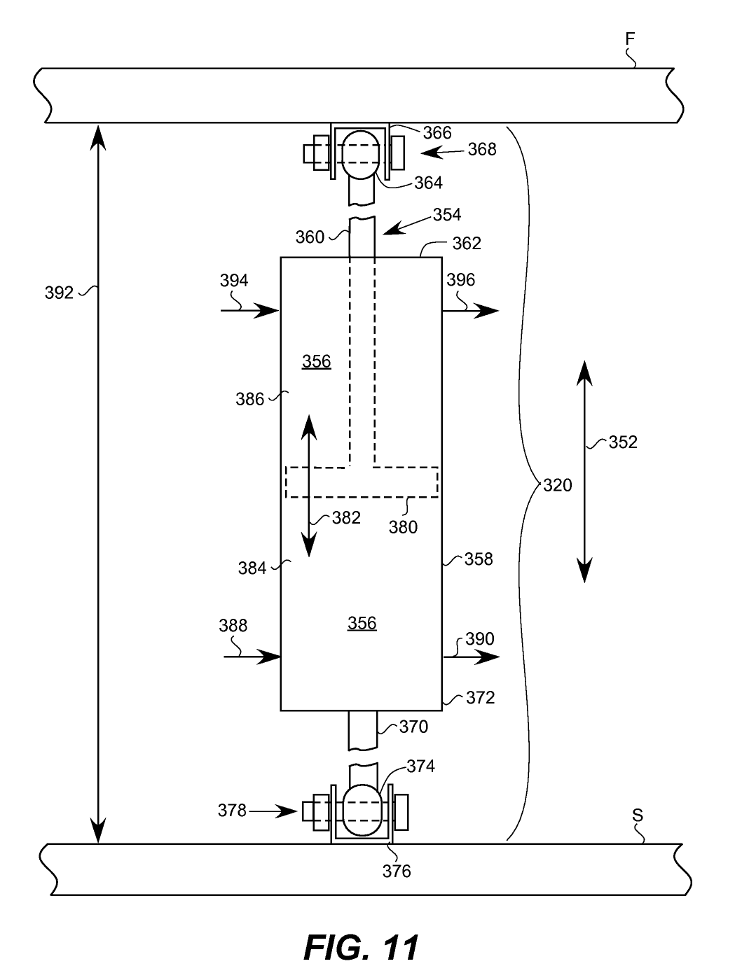

Referring now to FIG. 11, a hydraulic vehicle suspension kinetic energy recovery system 320 is deployed between the frame F and the suspension S of a vehicle. Kinetic energy associated with the movement of the frame F relative to the suspension S along arrow 32 causes a piston 354 to transfer hydraulic fluid 356 within a cylinder 358 to a hydraulic system high-pressure accumulator (not shown). The piston 354 has a stem 360 which extends upwardly from one end 362 of the cylinder 358 and terminates in a swivel eye 364. The swivel eye 364 of the piston stem 360 is secured within a U-shaped bracket 366 attached to the frame F by a bolt-and-nut assembly 368. A member 370 attached to the other end 372 of the cylinder 358 terminates in a swivel eye 374. The swivel eye 374 of the member 370 is secured within a U-shaped bracket 376 attached to the suspension S by a bolt-and-nut assembly 378.

Still referring fo FIG. 11, the piston 354 has a head 380 which moves up and down along arrow 382 within the cylinder 358 as the frame F and the suspension S move alternately closer together and farther apart along the arrow 352 as a result of roadway irregularities. The position of the piston head 380 within the cylinder 358 defines a lower hydraulic fluid cavity 384 below the piston head 380 and an upper hydraulic fluid cavity 386 above the piston head 380. An inlet conduit 388 provides one-way flow of hydraulic fluid 356 from a low-pressure reservoir (not shown) to the lower hydraulic fluid cavity 384, and an outlet conduit 390 provides one-way flow of the hydraulic fluid 356 from the lower hydraulic fluid cavity 384 to the high-pressure accumulator (not shown). The vehicle suspension kinetic energy recovery system 320 shown in FIG. 11 is illustrated when the vehicle is at rest, resulting in an at-rest distance 392 between the frame F and the suspension S. An inlet conduit 392 provides one-way flow of hydraulic 356 from the low-pressure reservoir (not shown) to the upper hydraulic fluid cavity 386, and an outlet conduit 394 provides one-way flow of the hydraulic fluid 356 from the upper hydraulic fluid cavity 386 to the high-pressure accumulator (not shown).

It will be understood by one skilled in the art that the vehicle suspension kinetic energy recovery system 320 is, essentially, a double-action positive-displacement piston pump. As the frame F and the suspension S move closer together along the arrow 352 due to roadway irregularities, the piston 354 of the vehicle suspension kinetic energy recovery system 320 charges the high-pressure hydraulic accumulator with hydraulic fluid 356 through the one-way outlet conduit 390 in the lower hydraulic fluid cavity 384 (a discharge stroke). At the same time, the piston 354 pulls hydraulic fluid 356 into the upper hydraulic fluid cavity 386 through the one-way inlet conduit 392 (a suction stroke). As the frame F and the suspension S move apart along the arrow 352 due to roadway irregularities, the piston 354 charges the high-pressure hydraulic accumulator with hydraulic fluid 356 through the one-way outlet conduit 394 in the upper hydraulic fluid cavity 386 (a discharge stroke). Simultaneously, the piston 354 pulls hydraulic fluid 356 into the lower hydraulic fluid cavity 384 through the one-way inlet conduit 388 (a suction stroke). As a result, any movement of the frame F toward or away from the suspension S result in conversion of kinetic energy to useful energy in the form of high-pressure hydraulic fluid stored in the high-pressure accumulator.

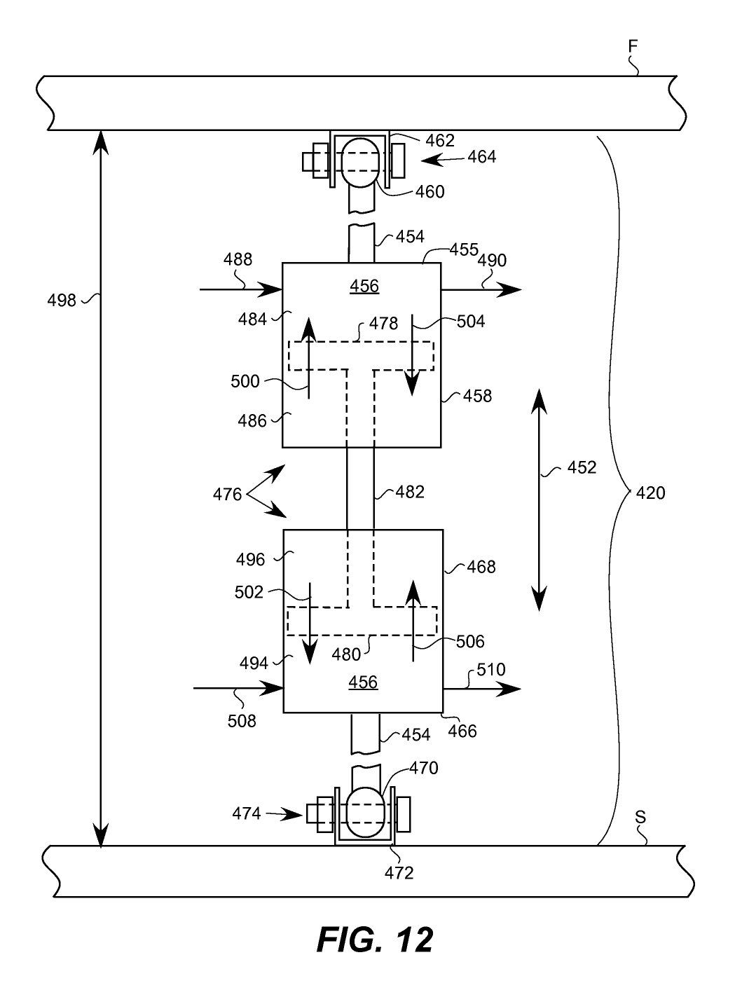

Referring now to FIG. 12, a hydraulic vehicle suspension kinetic energy recovery system 420 is deployed between the frame F and the suspension S of a vehicle. As the vehicle travels along a roadway, irregularities in the roadway cause the frame F to move with respect to the suspension S along arrow 452. One end of an elongated support member 454 is rigidly attached to the top end 455 of an upper cylinder 458. The other end of the elongated support member 454 terminates in a swivel eye 460. The swivel eye 460 is secured within a U-shaped bracket 462 attached to the frame F by a bolt-and-nut assembly 464. One end of a second elongated Support member 454 is rigidly attached to the bottom end 466 of a lower cylinder 468. The other end of the second elongated support member 454 terminates in a swivel eye 470. The swivel eye 470 of the second elongated support member 454 is secured within a U-shaped bracket 472 attached to the suspension S by a bolt-and-nut assembly 474.

Still referring fo FIG. 12, a double-headed piston 476 has two heads 478, 480 connected by a piston stem 482. One head 478 of the double-headed piston 476 is positioned within the upper cylinder 458 and defines an upper cylinder hydraulic fluid cavity 484 above the piston head 478 and an open cavity 486 below the piston head 478. An inlet conduit 488 provides one-way flow of hydraulic fluid 456 from a low-pressure reservoir (not shown) to the hydraulic fluid cavity 484, and an outlet conduit 490 provides one-way flow of the hydraulic fluid 456 from the hydraulic fluid cavity 484 to the high-pressure accumulator (not shown). The other head 480 of the double-headed piston 476 is positioned within the lower cylinder 468 and defines a lower cylinder hydraulic fluid cavity 494 below the piston head 480 and an open cavity 496 above the piston head 480.

The vehicle suspension kinetic energy recovery system 420 shown in FIG. 12 is illustrated when the vehicle is at rest, resulting in an at-rest distance 498 between the frame F and the suspension S

Still referring to FIG. 12, as the frame F and the suspension S move closer together along the arrow 452 in a compression cycle, the piston head 478 is forced upwardly toward the frame F within the upper cylinder 458 along arrow 500, thereby charging a high-pressure hydraulic accumulator (not shown) with hydraulic fluid 456 through a one-way outlet conduit 490 (a discharge stroke). Simultaneously, the piston head 480 is forced downwardly in the direction of the suspension S within the lower cylinder 468 along arrow 502, thereby further charging the high-pressure accumulator with hydraulic Fluid 456 through a one-way outlet conduit 510 (a discharge stroke).

As the frame F and the suspension S move farther apart along the arrow 452 in an extension cycle, the piston head 478 is forced downwardly toward the suspension S within the upper cylinder 458 along arrow 504, thereby pulling hydraulic fluid 456 from a low-pressure hydraulic fluid reservoir into the cavity 484 through a one-way inlet conduit 488 (a suction stroke). Simultaneously, the piston head 480 is forced upwardly in the direction of the frame F within the lower cylinder 468 along arrow 506, thereby pull hydraulic fluid from a low-pressure hydraulic fluid reservoir into the cavity 494 through a one-way inlet conduit 508 (a suction stroke).

It will be understood that appropriate sealing rings are required between the piston heads 478, 480 and the interior surfaces of the cylinders 458, 468, respectively. Because the structure of pumps and hydraulic cylinders is well known in the art, the details of the sealing rings and other components have been omitted for the sake of clarity.

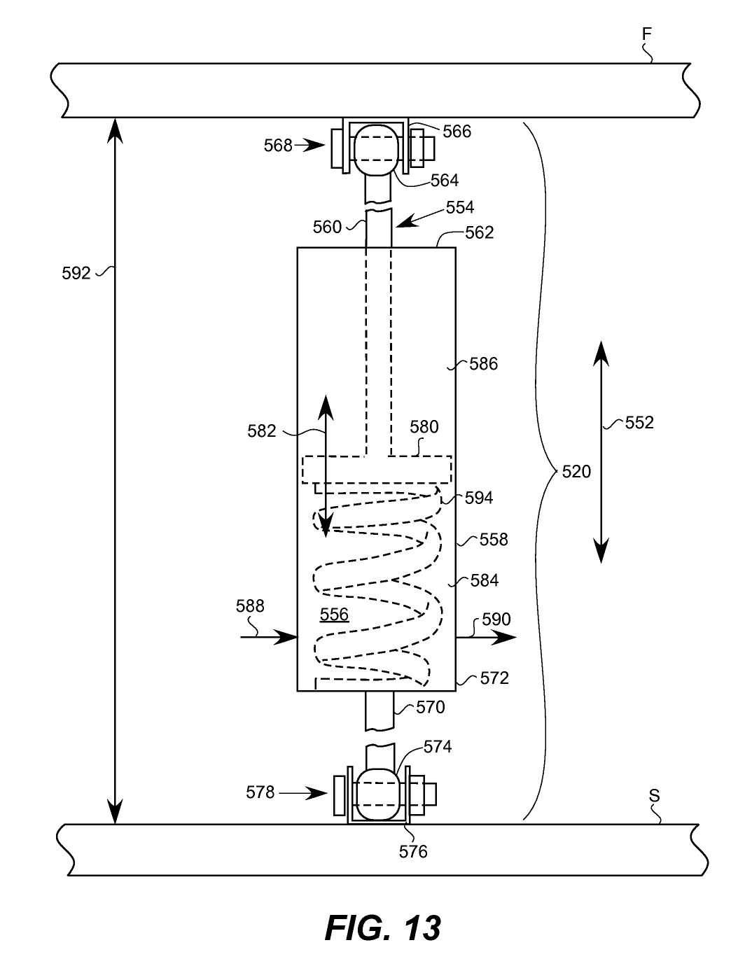

Referring now to FIG. 13, a hydraulic vehicle suspension kinetic energy recovery system 520 is deployed between the frame F and the suspension S of a vehicle. Kinetic energy associated with the movement of the frame F relative to the suspension S along arrow 552 causes a piston 554 to transfer hydraulic fluid 556 within a cylinder 558 to a hydraulic system high-pressure accumulator (not shown). The piston 554 has a stem 560 which extends upwardly from one end 562 of the cylinder 558 and terminates in a swivel eye 564. The swivel eye 564 of the piston stem 560 is secured within a U-shaped bracket 566 attached to the frame F by a bolt-and-nut assembly 568. A member 570 attached to the other end 572 of the cylinder 558 terminates in a swivel eye 574. The swivel eye 574 of the member 570 is secured within a U-shaped bracket 576 attached to the suspension S by a bolt-and-nut assembly 578.

Still referring fo FIG. 13, the piston 554 has a head 580 which moves up and down along arrow 582 within the cylinder 558 as the frame F and the suspension S move alternately closer together and farther apart along the arrow 552 as a result of roadway irregularities. The position of the piston head 580 within the cylinder 558 defines a hydraulic fluid cavity 584 below the piston head 580 and an open cavity 586 above the piston head 580. An inlet conduit 588 provides one-way flow of hydraulic fluid 556 from a low-pressure reservoir (not shown) to the hydraulic fluid cavity 584, and an outlet conduit 590 provides one-way flow of the hydraulic fluid 556 from the hydraulic fluid cavity 584 to the high-pressure accumulator (not shown). The vehicle suspension kinetic energy recovery system 520 shown in FIG. 13 is illustrated when the vehicle is at rest, resulting in an at-rest distance 592 between the frame F and the suspension S.

Still referring to FIG. 13, a suspension coil spring 594 disposed within the hydraulic fluid cavity 584 resists compression of the frame F toward the suspension S. It will be understood by one skilled in the art that the energy vehicle suspension kinetic energy recovery system 520 of FIG. 13 performs the function of a shock absorber as well as converting kinetic energy associated with suspension motion to useful energy. Thus the energy vehicle suspension kinetic energy recovery system 520 can be deployed between the frame F and the suspension S as a shock absorber. During the compression cycle, hydraulic fluid 556 is forced from the hydraulic fluid cavity 584 through the outlet conduit 590 to the high-pressure accumulator (not shown) in a discharge stroke. During the extension cycle, hydraulic fluid 556 is pulled into the hydraulic fluid cavity 584 through the inlet conduit 588 from a low pressure hydraulic fluid reservoir (not shown) in a suction stroke.

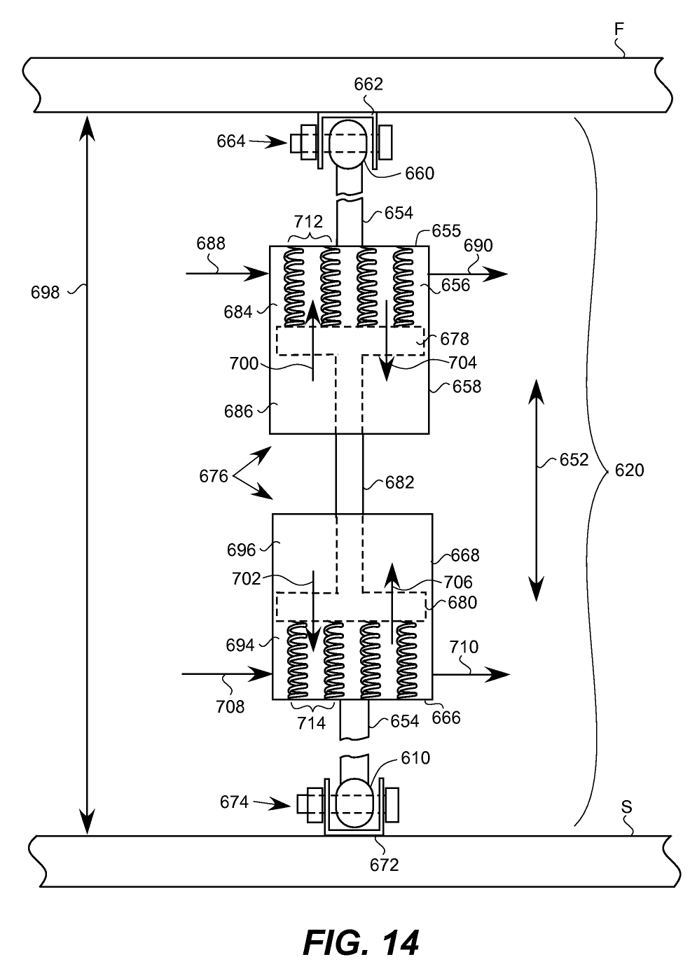

Referring now to FIG. 14, a hydraulic vehicle suspension kinetic energy recovery system 620 is deployed between the frame F and the suspension S of a vehicle. One end of an elongated support member 654 is rigidly attached to the top end 655 of an upper cylinder 658. The other end of the elongated support member 654 terminates in a swivel eye 660. The swivel eye 660 is secured within a U-shaped bracket 662 attached to the frame F by a bolt-and-nut assembly 664. One end of a second elongated support member 654 is rigidly attached to the bottom end 666 of a lower cylinder 668. The other end of the second elongated support member 654 terminates in a swivel eye 670. The swivel eye 670 of the second elongated support member 654 is secured within a U-shaped bracket 672 attached to the suspension S by a bolt-and-nut assembly 674.

Still referring fo FIG. 14, a double-headed piston 676 has two heads 678, 680 connected by a common piston stem 682. One head 678 of the double-headed piston 676 is positioned within the upper cylinder 658 and defines an upper cylinder hydraulic fluid cavity 684 above the piston head 678 and an open cavity 686 below the piston head 678. An inlet conduit 688 provides one-way flow of hydraulic fluid 656 from a low-pressure reservoir (not shown) to the hydraulic fluid cavity 684, and an outlet conduit 690 provides one-way flow of the hydraulic fluid 656 from the hydraulic fluid cavity 684 to the high-pressure accumulator (not shown). The other head 680 of the double-headed piston 676 is positioned within the lower cylinder 668 and defines a lower cylinder hydraulic fluid cavity 694 below the piston head 680 and an open cavity 696 above the piston head 680.

The vehicle suspension kinetic energy recovery system 620 shown in FIG. 14 is illustrated when the vehicle is at rest, resulting in an at-rest distance 698 between the frame F and the suspension S. A set of return coil springs 812 is disposed within the hydraulic fluid cavity 684 of the upper cylinder 658, and a second set of return coil springs 814 is disposed within the hydraulic fluid cavity 694 of the lower cylinder 668.

Still referring to FIG. 14, as the frame F and the suspension S move closer together along the arrow 652, the piston head 678 is forced upwardly toward the frame F within the upper cylinder 658 along arrow 700, thereby charging a high-pressure hydraulic accumulator (not shown) with hydraulic fluid 656 through the one-way outlet conduit 690. Simultaneously, the piston head 680 is forced downwardly in the direction of the suspension S within the lower cylinder 668 along arrow 702, thereby further charging the high-pressure accumulator with hydraulic fluid 756 through a one-way outlet conduit 810. Thus the compression cycle, wherein the piston heads 678, 680 move toward the closed ends 655, 666 of the cylinders 658, 668, respectively, produces a discharge stroke.

As the frame F and the suspension S move farther apart along the arrow 652, the piston head 678 is forced downwardly toward the suspension S within the upper cylinder 658 along arrow 704, thereby pulling hydraulic fluid 656 from a low-pressure hydraulic fluid reservoir into the cavity 684 through a one-way inlet conduit 688. Simultaneously, the piston head 680 is forced upwardly in the direction of the frame F within the lower cylinder 668 along arrow 706, thereby pulling hydraulic fluid from a low-pressure hydraulic fluid reservoir into the cavity 694 through a one-way inlet conduit 708. Thus the extension cycle, wherein the return coil springs 712, 714 force the piston heads 678, 680 away from the closed ends 655, 666 of the cylinders 658, 668, respectively, produces a suction stroke.

It will be understood that appropriate sealing rings are required between the piston heads 678, 680 and the interior surfaces of the cylinders 658, 668, respectively. Because the structure of pumps and hydraulic cylinders is well known in the art, the details of the sealing rings and other components have been omitted for the sake of clarity.

Still referring to FIG. 14, the return coil springs 712 disposed within the hydraulic fluid cavity 684 of the upper cylinder 658 and the return coil springs 714 disposed within the hydraulic fluid cavity 694 of the lower cylinder 668 resist compression of the frame F in the direction of the suspension S, thereby making the vehicle suspension kinetic energy recovery system 620 shown in FIG. 14 suitable for use as a shock absorber in a vehicle suspension.

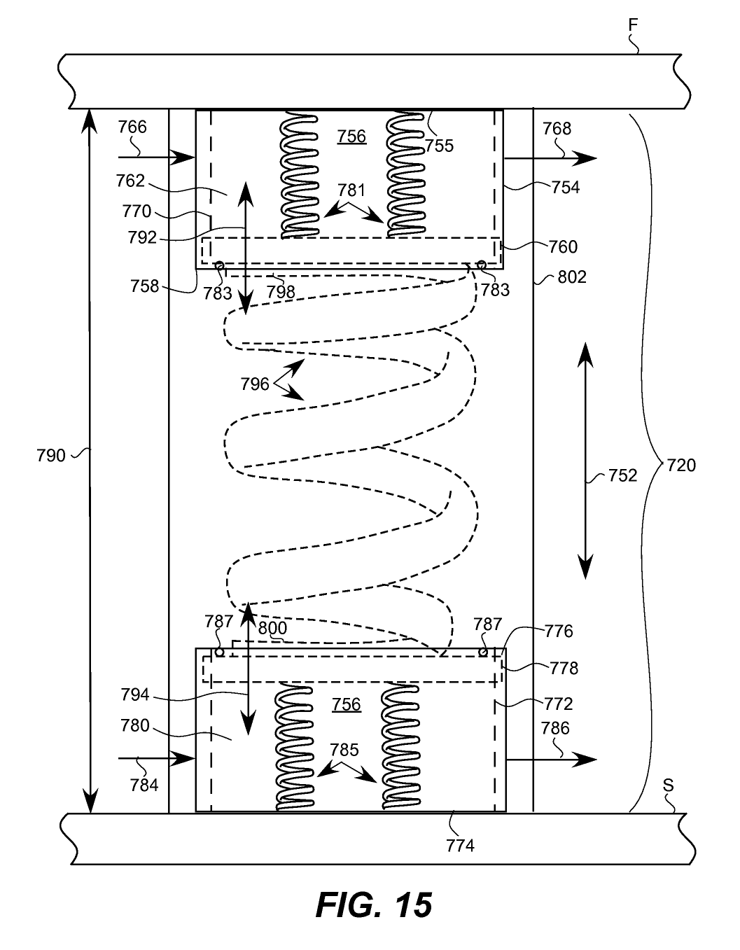

Referring now to FIG. 15, a vehicle suspension kinetic energy recovery system 720 is deployed between the frame F and the suspension S of a vehicle. It will be understood by one skilled in the art that the vehicle suspension kinetic energy recovery system 720 can be deployed between the frame F and the suspension S at any convenient location. It will be further understood by one skilled in the art that one or more vehicle suspension kinetic energy recovery system 720 devices can be used on a single vehicle. Kinetic energy associated with the movement of the frame F toward the suspension S along arrow 752 is used to transfer (i.e., to pump) hydraulic fluid to a hydraulic system high-pressure accumulator (not shown).

Still referring fo FIG. 15, an upper cylinder 754 is rigidly attached at a closed end 755 to the suspension S, and the other end 758 of the upper cylinder 754 is open. An upper piston head 760 is positioned within the upper cylinder 754 within an upper cylinder hydraulic fluid cavity 762. An inlet conduit 766 provides one-way flow of hydraulic fluid 756 from a low-pressure reservoir (not shown) to the upper cylinder hydraulic fluid cavity 762, and an outlet conduit 768 provides one-way flow of the hydraulic fluid 756 from the upper cylinder hydraulic fluid cavity 762 to a high-pressure accumulator (not shown). Piston head guides 770 maintain alignment of the upper piston head 760 within the upper cylinder 754. Return coil springs 781 disposed within the upper cylinder hydraulic fluid cavity 762 bias the piston head 760 away from the closed end 755 of the upper cylinder 754 when the vehicle is in the at-rest position shown in FIG. 15. A retaining ring 783 retains the piston head 760 within the upper cylinder hydraulic fluid cavity 762.

Still referring fo FIG. 15, a lower cylinder 772 is rigidly attached at one closed end 774 to the suspension S. The other end 776 of the lower cylinder 772 is open. A lower piston head 778 is positioned within the lower cylinder hydraulic fluid cavity 780. An inlet conduit 784 provides one-way flow of hydraulic fluid 756 from a low-pressure reservoir (not shown) to the lower cylinder hydraulic fluid cavity 780, and an outlet conduit 786 provides one-way flow of the hydraulic fluid 756 from the lower cylinder hydraulic fluid cavity 780 to the high-pressure accumulator. Piston head guides 788 maintain alignment of the lower piston head 778 within the lower cylinder 772. Return coil springs 785 disposed within the lower cylinder hydraulic fluid cavity 780 bias the piston head 778 in the at-rest position shown in FIG. 15. A retaining ring 787 retains the piston head 778 within the lower cylinder hydraulic fluid cavity 780.

The vehicle suspension kinetic energy recovery system 720 shown in FIG. 15 is illustrated when the vehicle is at rest, resulting in an at-rest distance 790 between the frame F and the suspension S. A suspension coil spring 796 is disposed between the upper piston head 760 and the lower piston head 778. One end 798 of the suspension coil spring 796 biases the upper cylinder piston head 760 just slightly against the piston head 760 within the upper cylinder hydraulic fluid cavity 764. The other end 800 of the suspension coil spring 796 biases the lower cylinder piston head 778 just slightly against the piston head 778 within the lower cylinder hydraulic fluid cavity 780. A protective shroud 802 shields the remaining components of the vehicle suspension kinetic energy recovery system 720 from dirt, dust, debris, and other roadway contaminants.

It will be understood by one skilled in the art that the suspension coil spring 796 is sized to provide a slight bias against the piston heads 760 and 778 when the frame F and the suspension S are in the at-rest position shown in FIG. 15. The return coil springs 781 bias the upper cylinder piston head 760 against one end 798 of the suspension coil spring 796. The return coil springs 785 bias the lower cylinder piston head 778 against the other end 800 of the suspension coil spring 796. As the frame F and the suspension S move closer together along the arrow 752, the suspension coil spring 796 forces the upper cylinder piston head 760 upwardly toward the frame F within the upper cylinder 754 along arrow 792, thereby charging a high-pressure hydraulic accumulator (not shown) with the hydraulic fluid 756 through the one-way outlet conduit 768. Simultaneously, the suspension coil spring 796 forces the lower cylinder piston head 778 downwardly in the direction of the suspension S within the lower cylinder 772 along arrow 794, thereby further charging the high-pressure accumulator with hydraulic fluid 756 through the one-way outlet conduit 786.

As the frame F and the suspension S move farther apart along the arrow 752, the suspension coil spring 796 relaxes and the return coil springs 781 within the upper cylinder hydraulic fluid cavity 762 move the piston head 760 downwardly toward the suspension S within the upper cylinder 754 along arrow 792, thereby pulling hydraulic fluid 756 from a low-pressure hydraulic fluid reservoir into the upper cylinder hydraulic fluid cavity 784 through the one-way inlet conduit 766 (a suction stroke). Simultaneously, the return coil springs 785 in the lower cylinder hydraulic fluid cavity 780 move the lower cylinder piston head 778 in the direction of the suspension S within the lower cylinder hydraulic fluid cavity 780 along arrow 794, thereby pulling hydraulic fluid 756 from a low-pressure hydraulic fluid reservoir into the lower cylinder hydraulic fluid cavity 780 through the one-way inlet conduit 784 (a suction stroke). Thus the vehicle suspension kinetic energy conversion system 720 of FIG. 15 functions as a high pressure hydraulic pump. During the compression cycle, the suspension coil spring 796 moves the pistons 760, 778 in a discharge stroke. During the extension cycle, the suspension coil spring 796 relaxes and the return coils springs 781, 785 within the hydraulic fluid cavities 762, 760, respectively, move the pistons 760, 769 away from the closed ends 758, in a suction stroke.

It will be understood by one skilled in the art that the suspension coil spring 796 absorbs a small portion of kinetic energy available from the movement of the suspension S relative to the frame F. The selection of the suspension coil spring 796 affects both the ride of the vehicle and the amount of kinetic energy available to power the pump-like piston-cylinder combinations of the vehicle suspension kinetic energy recovery system 720. A firmer suspension coil spring 796 will absorb less kinetic energy and provide for more energy recovery, whereas a relatively softer suspension coil spring 796 will absorb more kinetic energy and reduce the amount of energy recovered. It will be further understood by one skilled in the art that the vehicle suspension kinetic energy recovery system 720 shown in FIG. 15 is suitable for use as a shock absorber.

As noted above, any convenient number of vehicle suspension kinetic energy recovery systems can be deployed between the frame F and the suspension S of a vehicle. Similarly, the energy recovered from one vehicle, such as the trailer of a tractor-trailer rig can be transferred to another vehicle, such as the tractor of the tractor-trailer rig. For a tractor-trailer rig consisting of a tractor and two trailers, the tractor and both trailers are potential energy-gathering devices wherein the kinetic energy associated with suspension movement is converted to useful energy for use in vehicle systems.

Referring once again to FIG. 1, in light of the disclosures with respect to FIGS. 2-15, it will understood by one skilled in the art that an air compressor deployed between the frame F and the suspension S of a vehicle will convert the vehicle suspension kinetic energy to energy in the form of compressed air for use in powering vehicle pneumatic systems.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A device for recovering the kinetic energy relating to the vertical motion of a vehicle suspension relative to the frame of the vehicle when the vehicle is traveling on a roadway, the device comprising:
energy conversion means for converting the energy relating to the vertical motion of the vehicle frame relative to the vehicle suspension to a form of energy which can be stored on the vehicle for later use in powering vehicle systems; and
mounting means for mounting the energy conversion means between the frame and the suspension of the vehicle.

2. The device of claim 1 wherein the mounting means for mounting the energy conversion means between the frame and suspension further comprises:
an upper mount for attaching the energy conversion means to the vehicle frame; and
a lower mount for attaching the energy conversion means to the vehicle suspension.

3. The device of claim 2 wherein the upper mount for attaching the energy conversion means to the vehicle frame further comprises:
a frame swivel eye attached to the energy conversion means;
a U-shaped frame bracket rigidly attached to the frame; and
a bolt-and-nut assembly securing the frame swivel eye within the frame U-shaped bracket.

4. The device of claim 2 wherein the lower mount for attaching the energy conversion means to the vehicle suspension further comprises:
a suspension swivel eye attached to the energy conversion means;
a U-shaped suspension bracket rigidly attached to the suspension; and
a bolt-and-nut assembly securing the suspension swivel eye within the suspension U-shaped bracket.

5. The device of claim 2 wherein the energy conversion means is a hydraulic pump mounted between the vehicle frame and the vehicle suspension and wherein the hydraulic pump pulls hydraulic fluid from a low pressure hydraulic fluid reservoir and pumps the hydraulic fluid to a high pressure hydraulic accumulator.

6. The device of claim 5 wherein the hydraulic pump further comprises:
a cylinder having a closed end and an open end;
a piston having a piston head slidably disposed within the closed end of the cylinder and a piston stem extending from the open end of the cylinder, the piston head defining a hydraulic fluid cavity between the piston head and the closed end of the cylinder and an open cavity between the piston head and the open end of the cylinder;
a one-way inlet conduit permitting flow from the low pressure hydraulic fluid reservoir into the hydraulic fluid cavity;
a one-way outlet conduit permitting flow from the hydraulic fluid cavity to the high pressure hydraulic accumulator;
wherein the upper mount is attached to the piston stem distal from the piston head and secures the piston stem to the frame;
wherein the lower mount is attached to the closed end of the cylinder and secures the closed end of the cylinder to the suspension; and
wherein movement of the frame relative to the suspension causes the piston to alternately pull hydraulic into the hydraulic fluid cavity from the low pressure hydraulic fluid reservoir and discharge high pressure hydraulic fluid to the high pressure hydraulic accumulator.

7. The device of claim 5, wherein the hydraulic pump further comprises:
a cylinder having a closed end and an open end;
a piston having a piston head slidably disposed within the closed end of the cylinder and a piston stem extending from the open end of the cylinder, the piston head defining a hydraulic fluid cavity between the piston head and the closed end of the cylinder and an open cavity between the piston head and the open end of the cylinder;
a one-way inlet conduit permitting flow from the low pressure hydraulic fluid reservoir into the hydraulic fluid cavity;
a first one-way outlet conduit, a second one-way outlet conduit, and a third one-way outlet conduit, the one-way outlet conduits spaced along the cylinder to permit flow of the hydraulic fluid from the hydraulic fluid cavity to the high pressure accumulator;
wherein the first one-way outlet conduit is positioned in an upper location and has a first restriction therein restricting flow of hydraulic fluid through the first to a predetermined flow rate;
wherein the second one-way outlet conduit is positioned in an intermediate location and has a second restriction therein so that permitted flow of hydraulic fluid through the second one-way outlet conduit is reduced relative to permitted flow of hydraulic fluid through the first one-way outlet;
wherein the third one-way outlet conduit is positioned proximate the closed end of the cylinder and has a third restriction therein so that permitted flow through of hydraulic flow through the third one-way outlet is reduced relative to the permitted flow of hydraulic fluid through the second one-way outlet conduit;
wherein the upper mount is attached to the piston stem distal from the piston head and secures the piston stem to the frame;
wherein the lower mount is attached to the closed end of the cylinder and secures the closed end of the cylinder to the suspension; and
wherein movement of the frame relative to the suspension causes the piston to alternately pull hydraulic into the hydraulic fluid cavity from the low pressure hydraulic fluid reservoir and discharge high pressure hydraulic fluid to the high pressure hydraulic accumulator through, progressively as the piston head moves from the open end of the cylinder toward the closed end of the cylinder, the combined first, second, and third one-way outlet conduits, then through the combined second and third one-way outlet conduits, and then through the third one-way outlet conduit only, so that movement of the frame toward the suspension is progressively resisted as the piston head moves past the first one-way outlet conduit, the second one-way outlet conduit, and the third one-way outlet conduit.

8. The device of claim 7, wherein the hydraulic pump is disposed within a suspension coil spring, and wherein one end of the suspension coil spring is attached to the frame and the other end of the suspension coil spring is attached to the suspension.

9. The device of claim 5, wherein the hydraulic pump further comprises:
a cylinder having a closed lower end and a closed upper end;
a piston having a piston head slidably disposed within the cylinder and a piston stem extending upwardly through the upper end of the cylinder, the piston head defining an upper hydraulic fluid cavity between the piston head and the upper end of the cylinder and a lower hydraulic fluid cavity between the piston head and the lower end of the cylinder;
an upper cavity one-way inlet conduit permitting flow from the low pressure hydraulic fluid reservoir into the upper hydraulic fluid cavity;
an upper cavity one-way outlet conduit permitting flow from the upper hydraulic fluid cavity to the high pressure hydraulic accumulator;
a lower cavity one-way inlet conduit permitting flow from the low pressure hydraulic fluid reservoir into the lower hydraulic fluid cavity;
a lower cavity one-way outlet conduit permitting flow from the lower hydraulic fluid cavity to the high pressure hydraulic accumulator;
wherein the upper mount is attached to the piston stem distal from the piston head and secures the piston stem to the frame;
wherein the lower mount is attached to the lower end of the cylinder and secures the lower end of the cylinder to the suspension;
wherein movement of the frame toward suspension in a compression cycle causes the piston to simultaneously pull hydraulic fluid from the low pressure hydraulic fluid reservoir into the upper hydraulic fluid cavity through the upper cavity one-way inlet conduit and discharge high pressure hydraulic fluid from the lower hydraulic fluid cavity to the high pressure hydraulic accumulator through the lower cavity one-way outlet conduit; and
wherein movement of the frame away from the suspension in an extension cycle causes the piston to simultaneously discharge hydraulic fluid from the upper hydraulic fluid cavity to the high pressure hydraulic accumulator through the upper cavity one-way outlet conduit and pull hydraulic fluid from the low pressure fluid reservoir into the lower hydraulic fluid cavity through the lower cavity one-way inlet conduit, thereby charging the high pressure hydraulic accumulator during both the compression cycle and the extension cycle.

10. The device of claim 5, wherein the hydraulic pump further comprises:
an upper cylinder having a closed upper end and a lower end;
a lower cylinder having a closed lower end and an upper end;
a piston having two piston heads attached to a common piston stem positioned between the upper cylinder and the lower cylinder, wherein one piston head is slidably disposed within the upper cylinder and defines an upper hydraulic fluid cavity between the piston head and the closed upper end of the cylinder and an upper open cavity between the piston head and the lower end of the upper cylinder, and wherein the other piston head is slidably disposed within the lower cylinder and defines a lower hydraulic fluid cavity between the piston head and the closed lower end of the lower cylinder and a lower open cavity between the piston head and the upper end of the lower cylinder;
an upper hydraulic fluid cavity one-way inlet conduit permitting flow from the low pressure hydraulic fluid reservoir into the upper hydraulic fluid cavity;
an upper hydraulic fluid cavity one-way outlet conduit permitting flow from the upper hydraulic fluid cavity to the high pressure hydraulic accumulator;
a lower hydraulic fluid cavity one-way inlet conduit permitting flow from the low pressure hydraulic fluid reservoir into the lower hydraulic fluid cavity;
a lower hydraulic fluid cavity one-way outlet conduit permitting flow from the lower hydraulic fluid cavity to the high pressure hydraulic accumulator;
wherein the upper mount is attached to the closed end of the upper cylinder and secures the piston stem to the frame;
wherein the lower mount is attached to the closed end of the lower cylinder and secures the closed end of the lower cylinder to the suspension;
wherein movement of the frame toward suspension in a compression cycle causes the piston heads to discharge high pressure hydraulic fluid from the upper hydraulic fluid cavity through the upper hydraulic fluid cavity one-way outlet conduit to the high pressure hydraulic accumulator and from the lower hydraulic fluid cavity through the lower hydraulic fluid cavity one-way outlet to the high pressure hydraulic accumulator; and
wherein movement of the frame away from the suspension in an extension cycle causes the piston heads to simultaneously pull hydraulic fluid from the low pressure hydraulic fluid reservoir into the upper hydraulic fluid cavity through the upper hydraulic fluid cavity one-way inlet conduit and from the low pressure hydraulic fluid reservoir into the lower hydraulic fluid cavity through the lower hydraulic fluid cavity one-way inlet conduit, thereby charging the high pressure hydraulic accumulator during both the compression cycle and filling the upper and lower hydraulic fluid cavities during the extension cycle.

11. The device of claim 5 wherein the hydraulic pump further comprises:
a cylinder having a closed end and an open end;
a piston having a piston head slidably disposed within the closed end of the cylinder and a piston stem extending from the open end of the cylinder, the piston head defining a hydraulic fluid cavity between the piston head and the closed end of the cylinder and an open cavity between the piston head and the open end of the cylinder;
a one-way inlet conduit permitting flow from the low pressure hydraulic fluid reservoir into the hydraulic fluid cavity;
a one-way outlet conduit permitting flow from the hydraulic fluid cavity to the high pressure hydraulic accumulator;
wherein the upper mount is attached to the piston stem distal from the piston head and secures the piston stem to the frame;
wherein the lower mount is attached to the closed end of the cylinder and secures the closed end of the cylinder to the suspension;
a coil spring disposed within the hydraulic fluid cavity, one end of the coil spring resting against the piston head and the other end of the coil spring resting against the closed end of the cylinder;
wherein, during the compression cycle, first the coil spring absorbs a portion of the kinetic energy related to the movement of the suspension with respect to the frame and then the piston head moves downward within the hydraulic fluid cavity, thereby discharging high pressure hydraulic fluid to the high pressure hydraulic accumulator; and
wherein, during the extension cycle, the coil spring assists the movement of the piston upwardly away from the closed end of the cylinder so the piston pulls hydraulic fluid into the hydraulic fluid cavity.

12. The device of claim 10, further comprising:
a plurality of coil springs disposed within the upper hydraulic fluid cavity of the upper cylinder, one end of each coil spring resting against the upper piston head and the other end of each coil spring resting against the closed upper end of the upper cylinder;
a plurality of coil springs disposed within the lower hydraulic fluid cavity of the lower cylinder, one end of each coil spring resting against the lower piston head and the other end of each coil spring resting against the closed lower end of the lower cylinder;
wherein, during the compression cycle, the coil springs absorb a portion of the kinetic energy related to the movement of the suspension with respect to the frame; and
wherein, during the extension cycle, the coil spring assist the movement of the piston heads away from the closed ends of the upper and lower cylinders so the pistons pull hydraulic fluid into the upper and lower hydraulic fluid cavities from the low pressure hydraulic fluid reservoir.

13. The device of claim 5, wherein the hydraulic pump further comprises;
an upper cylinder having a closed upper end and a lower end;
a lower cylinder having a closed lower end and an upper end;
an upper cylinder piston head slidably disposed within the upper cylinder and secured by a retaining ring located at the lower end of the upper cylinder, the upper cylinder piston head cooperating with the closed upper end of the upper cylinder to define an upper hydraulic fluid cavity between the upper cylinder piston head and the closed upper end of the upper cylinder;
a lower cylinder piston head slidably disposed within the lower cylinder and secured by a retaining ring located at the upper end of the lower cylinder, the lower cylinder piston head cooperating with the closed lower end of the lower cylinder to define a lower hydraulic fluid cavity between the lower cylinder piston head and the closed lower end of the lower cylinder;
a plurality of upper cylinder return coil springs disposed within the upper hydraulic fluid cavity, one end of each of the upper cylinder return coil springs resting against the closed upper end of the upper cylinder and the other end of each of the upper cylinder return coil springs resting against the upper cylinder piston head;
a plurality of lower cylinder return coil springs disposed within the lower hydraulic fluid cavity, one end of each of the upper cylinder return coil springs resting against the closed lower end of the lower cylinder and the other end of each of the lower cylinder return coil springs resting against the lower cylinder piston head;
a suspension coil spring having two ends, one end of the suspension coil spring resting against the upper piston head distal from the upper hydraulic fluid cavity and the other end of the suspension coil spring resting against the lower piston head distal from the lower hydraulic fluid cavity;
wherein, during the compression cycle, the suspension coil spring absorbs a portion of the kinetic energy related to the movement of the suspension with respect to the frame; and
wherein, during the extension cycle, the return coil springs assist the movement of the piston heads away from the closed ends of the upper and lower cylinders so the pistons pull hydraulic fluid into the upper and lower hydraulic fluid cavities from the low pressure hydraulic fluid reservoir.

14. The device of claim 2, wherein the energy conversion means is an electric generator for generating electricity for use by vehicle electrical systems.

15. The device of claim 2, wherein the energy conversion means is an air compressor for producing compressed air for use by vehicle pneumatic systems.

16. A method of converting vehicle suspension kinetic energy related to movement of the vehicle frame with respect to the vehicle suspension to operate vehicle systems, the method comprising the steps of:
installing a converter between the frame and the suspension;
storing the converted energy; and
using the stored energy.

17. The method of claim 16, wherein the converter is a hydraulic pump, the converted energy is stored in a high pressure hydraulic accumulator, and the stored energy is used to drive hydraulically powered devices.

18. The method of claim 16, wherein the converter is a generator, the converted energy is stored in storage batteries, and the stored energy is used to drive electrical devices.

19. The method of claim 16, wherein the converter is an air compressor, the converted energy is stored in a pressure tank, and the stored energy is used to drive pneumatic devices.

20. The method of claim 16, wherein the converter comprises both a hydraulic pump and a generator, the converted energy is stored both in a high pressure hydraulic accumulator and in storage batteries, and the stored energy is used both to drive hydraulically powered devices and electrical devices.
